(19) United States
(12) Patent Application Publication
(10) Pub. No.: US 2011/0147419 A1
(43) Pub. Date: Jun. 23, 2011

(54) PRESSURE ACCUMULATION DISPENSER

(76) Inventors: Atsushi Tada, Tokyo (JP); Mitsuaki Shaduki, Yamaguchi (JP); Yoshiharu Hiraoka, Yamaguchi (JP)

(21) Appl. No.: 12/735,086

(22) PCT Filed: Dec. 8, 2008
(86) PCT No.: PCT/JP2008/072280

§ 371 Date: Mar. 8, 2011

(30) Foreign Application Priority Data
Dec. 14, 2007 (JP) 2007-324052

(51) Int. Cl. B05C 11/00

(52) U.S. Cl. 222/401

(57) ABSTRACT

[Problem] To provide by the present invention a pressure-accumulation dispenser that can be given a pressure-accumulation function with a simple structure.

[Means for Solving Problems] A pressure-accumulation dispenser pressurizes and injects liquid in a cylinder 11 from a nozzle portion 21 to the outside by sliding a piston portion 23 in the cylinder 11 up and down with rotation of a trigger includes a pressure-accumulation giving valve in the piston portion 23. The pressure-accumulation giving valve is formed of a piston valve 51, a spring body 52, and a piston cover 53, or the pressure-accumulation giving valve is formed of an insertion valve seat 54, a piston valve 51, a spring body 52, and a piston cover 53.

### TECHNICAL FIELD

The present invention relates to a pressure-accumulation dispenser.

In more detail, the present invention relates to a pressure-accumulation dispenser that pressurizes and injects liquid in a cylinder from a nozzle portion to outside by sliding a piston portion in the cylinder up and down by a trigger, the dispenser capable of injecting the liquid when the liquid in the cylinder has a pressure higher than a predetermined pressure.

Conventionally, as a means that injects liquid, such as a drug solution, into a predetermined portion, a dispenser is used.

And, to increase injection pressure, for example, a pressure-accumulation dispenser is provided (Patent Document 1).

However, such a pressure-accumulation dispenser adopts a principle of first applying pressure to air in a container and pressing the liquid surface with this applied pressure to air.

In the first stage, directly applying pressure to liquid is not performed, and therefore the mechanism is complex.

On the other hand, pressure-accumulation dispensers using a trigger have been developed, but the structure is complex nonetheless.
Patent Document 1: Japanese Unexamined Patent Application Publication No. 09-267062

### DISCLOSURE OF INVENTION

### Problem to be Solved by the Invention

The present invention has been devised based on such background technology as above, and is useful for overcoming the above-described technical problems.

That is, an object of the present invention is to provide a pressure-accumulation dispenser that can be given a pressure-accumulation function with a simple structure.

### Means for Solving the Problems

Thus, as a result of diligent studies on such problematic background as above, the inventors found that a pressure-accumulation device itself can be downsized by including a pressure-accumulation giving valve having a pressure-accumulation function inside a piston and, based on the findings, they completed the present invention.

That is, the present invention resides in: (1) a pressure-accumulation dispenser that pressurizes and injects liquid in a cylinder from a nozzle portion to outside by sliding a piston portion in the cylinder up and down with rotation of a trigger, the pressure-accumulation dispenser including a pressure-accumulation giving valve in the piston portion.

The present invention resides in: (2) the pressure-accumulation dispenser described in the above (1), wherein the pressure-accumulation giving valve is formed of a piston valve, a spring body that presses the piston valve onto a piston valve seat, and a piston cover that accommodates the piston valve and the spring body.

The present invention resides in: (3) the pressure-accumulation dispenser described in the above (1), wherein the pressure-accumulation giving valve is formed of an insertion valve seat, a piston valve that abuts on or is isolated from the insertion valve seat, a spring body that presses the piston valve onto the insertion valve seat, and a piston cover mounted on the insertion valve seat through press-fit to accommodate the piston valve and the spring body.

The present invention resides in: (4) the pressure-accumulation dispenser described in the above (2), wherein the pressure-accumulation giving valve is mounted by being pressed fit into a groove formed in the piston portion.

The present invention resides in: (5) the pressure-accumulation dispenser described in the above (3), wherein the insertion valve seat mounted by being pressed fit into a narrow diameter portion of the piston.

The present invention resides in: (6) the pressure-accumulation dispenser described in the above (2) or (3), wherein a collar portion is provided around the piston valve to seal inside of the piston cover to form an accommodating portion for the spring body.

The present invention resides in: (7) the pressure-accumulation dispenser described in the above (2) or (3), wherein the liquid in the cylinder passes through a passage hole formed in the piston cover and then through the piston valve seat.

The present invention resides in: (8) the pressure-accumulation dispenser described in the above (2) or (3), wherein the piston valve and the spring body are integrally molded.

The present invention resides in: (9) the pressure-accumulation dispenser described in the above (2) or (3), wherein the piston cover and the spring body are integrally molded.

The present invention resides in: (10) the pressure-accumulation dispenser described in the above (9), wherein the spring body is formed of a split blade spring integrally formed at a bottom of the piston cover, a tapered portion is formed inside of the piston valve, and the blade spring abuts on a tapered surface of the tapered portion to press the piston valve onto the valve seat.

The present invention resides in: (11) the pressure-accumulation dispenser described in the above (1), wherein a large diameter portion is provided on a lower inner radius surface of the cylinder, and a plurality of protrusions are formed on the large diameter portion.

The present invention resides in: (12) a pressure-accumulation dispenser that pressurizes and injects liquid in a cylinder from a nozzle portion to outside by sliding a piston portion in the cylinder up and down with rotation of a trigger, the pressure-accumulation dispenser including: a base body including a cylinder therein and mountable on an opening portion of a container body; a cover body removably engaged with the base body; a piston structure formed of a bendable coupling portion that couples the nozzle portion engaging with the base body and the piston portion together; a trigger rotatably mounted on the base body so as to slide the piston up and down in the cylinder; and a pressure-accumulation giving valve disposed in the piston portion, and the pressure-accumulation giving valve formed of a piston valve, a spring body that presses the piston valve onto a piston valve seat, and a piston cover that accommodates the piston valve and the spring body.

The present invention resides in: (13) the pressure-accumulation dispenser described in the above (8), wherein many fins are formed around the coupling portion of the piston structure.

Here, any configuration formed by combining the above (1) to (13) as appropriate can be adopted as long as the configuration is along the object of the present invention.

### Effects of the Invention

The pressure-accumulation dispenser of the present invention is a pressure-accumulation dispenser that pressurizes and injects liquid in a cylinder 11 from a nozzle portion 21 to outside by sliding a piston portion 23 in the cylinder 11 up and down with rotation of a trigger 3, and includes a pressure-accumulation giving valve 5 in the piston portion. Therefore, the pressure-accumulation giving valve 5 is accommodated in the piston portion 23, and the capacity of a portion having a pressure-accumulation function is decreased.

By mounting on a conventional dispenser of a direct pressure type without including a pressure-accumulation function, a pressure-accumulation dispenser can be easily achieved.

The pressure-accumulation giving valve 5 is formed of a piston valve 51, a spring body 52 that presses the piston valve 51 onto a piston valve seat, and a piston cover 53 that accommodates the piston valve 51 and the spring body 52, and therefore a pressure-accumulation function can be achieved with a simple structure.

The pressure-accumulation giving valve 5 is formed of an insertion valve seat, a piston valve 51 that abuts on or is isolated from the insertion valve seat, a spring body 52 that presses the piston valve 51 onto the insertion valve seat, and a piston cover 53 mounted on the insertion valve seat through press-fit to accommodate the piston valve 51 and the spring body 52, and therefore a pressure-accumulation function can be similarly achieved with a simple structure.

The pressure-accumulation giving valve 5 is mounted by being pressed fit into a groove formed in the piston portion 23, thereby achieving easy assembling.

The insertion valve seat is mounted by being pressed fit into a narrow diameter portion of the piston, thereby similarly achieving each assembling.

A collar portion is provided around the piston valve 51 to seal the inside of the piston cover 53 to form an accommodating portion for the spring body 52. With this, the spring body itself does not make contact with liquid, and rust can be prevented even when a metal spring is used.

A large diameter portion is provided on a lower inner radius surface of the cylinder, and a plurality of protrusions are formed on the large diameter portion. With this, a passage for fluid to pass though is formed between that portion and a second sealing valve 23B formed on the piston portion 23, thereby allowing the liquid to be cut off more clearly without dripping.

Also, at the time of starting use, the air present in the cylinder must be let escape to the outside to draw up the liquid from the container via a first valve FV, and it is possible to let the air escape from this passage.

With the piston valve 51 and the spring body 52 being integrally molded, the number of components is reduced, and assembling is easy.

Also, similarly, when the piston cover 53 and the spring body 52 are integrally formed, the number of components is reduced, and assembling is easy. At this time, when the spring body 52 is configured of three blade springs, the piston valve 51 can be stably moved up and down.

A piston structure 2 is used, which is formed of a bendable coupling portion that couples the nozzle portion 21 engaging with the base body 1 and the piston portion 23 together. Therefore, no additional component is required, the structure is simple, and a failure seldom occurs.

With many fins 22A formed around the coupling portion of the piston structure 2, the cross section is resistant to deformation, and liquid can pass through a passage without trouble.

With a coupling portion 22 of the piston structure 2 capable of being bent at an angle equal to or greater than 90 degrees, the trigger is resultantly given a reversion force.

Also, since an eaves portion 41 for covering an engaging portion between the base body 1 and a cover body 4 is provided to the cover body 4, the linking portion is not viewed from outside, thereby not impairing an aesthetic view.

### BEST MODE FOR CARRYING OUT THE INVENTION

### First Embodiment

In the following, best mode for carrying out the present invention is described based on the drawings.

The pressure-accumulation dispenser of the present invention is a pressure-accumulation dispenser that pressurizes and injects liquid in a cylinder 11 from a nozzle portion 21 to the outside by sliding a piston portion 23 in the cylinder 11 up and down with rotation of a trigger 3.

And, with a pressure-accumulation giving valve 5 included in the piston portion 23, a pressure-accumulation function can be achieved.

Although the pressure-accumulation dispenser may have the cylinder 11 laterally disposed or vertically disposed, an embodiment described below exemplarily has a structure with the cylinder 11 vertically disposed and uses the trigger 3.

FIG. 1 and FIG. 2 are diagrams depicting a pressure-accumulation dispenser according to a first embodiment of the present invention, depicting states before and after the trigger 3 is pulled, respectively.

The pressure-accumulation dispenser according to the first embodiment of the present invention pressures liquid in the cylinder 11 by sliding the piston portion 23 in the cylinder 11 up and down with rotation of the trigger 3 and, after pressure accumulation, injects the liquid at a dash from the nozzle portion to the outside, and is a so-called pressure-accumulation dispenser using the trigger 3.

More specifically, as depicted in FIG. 2, by pulling, that is, rotating, the trigger 3, the piston portion 23 is slid downward and, when a pressure-accumulation function works to increase the fluid pressure in the piston portion 23 by a predetermined amount, the liquid in the cylinder 11 is injected at a dash from the nozzle portion 21.

In the following, this pressure-accumulation dispenser is described in sequence.

This pressure-accumulation dispenser includes first a base body 1 directly mounted on a container, a cover body 4 mounted on the base body 1, the trigger 3 mounted on the base body 1, and a piston structure 2 capable of moving up and down by the trigger 3. An inner passage configured of these components includes a pressure-accumulation giving valve 5 corresponding to a second valve.

The material of these components is a synthetic resin material, and they are produced mainly through injection molding.

For example, as a material, polypropylene resin (PP) is used for a cap 13 and the base body 1, polyoxymethylene resin (POM) is used for the trigger 3, and linear low-density polyethylene resin (LLDPE), silicone resin, or the like is used for the piston structure 2.

(Base Body)

First, the base body 1 can be mounted on an opening portion of a container body X.

That is, the base body 1 is fixed to the opening portion of the container X by screwing (or engaging) the cap 13 to press a lower-end protrusion of the base body 1.

The base body 1 has a hollow tubular cylinder 11 capable of having the piston 23 accommodated therein and an expanded portion 12 extended upward from the cylinder 11.

Below the cylinder 11, which is part of the base body 1, a stepwise pipe portion 11A with a narrower diameter is formed.

At a lower portion of this stepwise pipe portion 11A, a first valve FV is provided.

Here, liquid in the container passes through this first valve FV to be drawn up into the cylinder 11.

Also, at a lower place of the stepwise pipe portion 11A, an introduction tube 11B that draws up the liquid at the bottom of the container for introduction to the first valve FV is integrally formed.

Here, the first valve FV abuts on a valve seat at a lower portion of the stepwise pipe portion 11A.

(Cover Body)

On the other hand, above the expanded portion 12 of the base body 1, the lid-like cover body 4 is removably engaged.

On the cover body 4 having an engaging portion contiguous to the base body 1, the eaves portion 41 for covering the engaging portion is formed therearound.

With this eaves portion 41 being provided, the engaging portion is covered so as not to be easily viewed from outside, thereby achieving an aesthetic outer view.

Also, the trigger 3, the piston structure 2, the cylinder 11, and others are exposed when the cover body 4 is removed from the base body and, therefore, advantageously, cleaning inside can be quite easily performed (refer to broken lines in FIG. 1).

Furthermore, when the dispenser is gripped, the base of a thumb abuts on a rear portion of the expanded portion 12. This plays a role of supporting the weight.

(Piston Structure)

In the cylinder 11 of the above-described base body 1, the two-stage hollow tubular piston portion 23 having at its upper portion a narrow diameter portion 23A is slidably included, and the piston portion 23 is part of the piston structure 2.

FIG. 3 is a diagram depicting the piston structure 2 and the pressure-accumulation giving valve 5.

The piston structure 2 is formed of an elastically deformable resin, such as linear low-density polyethylene (LLDPE) or silicone resin, integrally having the nozzle portion 21 at its tip and the piston portion 23 at its back and a coupling portion 22 coupling the nozzle portion 21 and the piston portion 23 together.

Here, only the coupling portion 22 can be formed of another elastomer resin excellent in elastic bendability.

The nozzle portion 21 is fixed by fitting in the tip of the cover body 4 and the tip of the base body 1.

On the surface of the coupling portion 22, a plurality of fins 22A are formed and, even when the material of the piston structure 2 including the coupling portion 22 is soft, such as silicone resin, the inner passage of the coupling portion 22 is not deformed to be crushed.

For the reason as above, the coupling portion 22 can be sufficiently bent at a degree equal to or greater than 90 degrees.

Also, since the coupling portion of the piston structure can be bent at an angle equal to or greater than 90 degrees, the piston structure can be made through injection molding in a linear state.

In this regard, in the piston structure 2, at the time of molding with a mold, its piston portion 23, coupling portion 22, and nozzle portion 21 are in a linear state as a whole.

Therefore, they can be bent for assembling.

Furthermore, after assembling, a reversion force advantageously occurs to the coupling portion 22.

Still further, from a mold of a predetermined size, piston structures can be molded as many as possible.

(Pressure-Accumulation Giving Valve)

Meanwhile, in the piston portion 23, the pressure-accumulation giving valve 5 is disposed.

This pressure-accumulation giving valve 5 is formed of, as depicted in FIG. 3, a piston valve 51 (refer to FIG. 4), a spring body 52 that presses the piston valve 51 onto a piston valve seat 23D, and a piston cover 53 for accommodating the piston valve 51 and the spring body 52 (refer to FIG. 5).

The piston valve 51 has a collar portion 51A therearound, and is hollow inside.

Its head portion is formed as a curved surface so as to be able to abut on the piston valve seat 23D.

Here, a protrusion 51B at the head portion serves as a guide at the time of assembling.

The piston valve 51 closes or releases a flow path of liquid by abutting on the piston valve seat 23D or being isolated from the piston valve seat 23D.

The spring body 52 is resiliently disposed between a base of the collar portion 51A of the piston valve 51 and a bottom of the piston cover 53 and, with the collar portion 51A making a pressure contact with the inner radius of the piston portion, the spring body 52 becomes in a state of being sealed and trapped in a space between the piston valve 51 and the piston cover 53.

The piston cover 53 is mounted with its upper end being pressed fit into a groove 23C formed in the piston portion 23.

In this manner, the piston cover 53 can be mounted on the piston portion 23. Therefore, even in a dispenser of a direct pressure type without using the pressure-accumulation giving valve 5, a pressure-accumulation function can be easily given.

Since the pressure-accumulation giving valve 5 is configured as above, when the trigger 3 is pulled to accumulate pressure in the cylinder 11 to increase the pressure by a predetermined amount, liquid enters at a dash between the piston valve seat 23D and the piston valve 51 to flow into the flow path.

Then, the liquid is injected from a nozzle N of the nozzle portion 21.

Meanwhile, in the pressure-accumulation giving valve 5, when liquid fills in an accommodating portion R with upward and downward movement of the piston valve 51, the motion of the piston valve 51 becomes slow to decrease the pressure-accumulation function and, at the worst, the internal pressure of the cylinder and the pressure of the accommodating portion R become equal to each other, thereby making the piston valve 51 impossible to open and disabling spraying. However, since the accommodating portion R of the spring body 52 is blocked by the collar portion 51A, liquid normally does not enter.

However, even in the event that liquid enters the accommodating portion R because the collar portion 51A is deformed due to some reason, the piston valve 51 is hollow inside and air is accumulated therein, and therefore, normally, the accommodating portion is not entirely filled with the entering liquid.

As a matter of course, at the time of inverted standing, the air inside the piston valve 51 moves to the bottom of the piston cover 53, and therefore the accommodating portion is not entirely filled with liquid.

Therefore, disabling spraying is avoided.

Here, as a material of each component of the pressure-accumulation giving valve 5, for example, polypropylene is adopted for the piston valve 51 and the piston cover 53, and a metal (SUS) is adopted for the spring body.

Here, as a suppression force for pressing the piston valve 51 onto the cylinder 11 valve, the independent spring body 52 may not be used, and a spring body integrally coupled to the piston valve 51 may be used.

In this case, the piston valve 51 and the spring body are integrally molded through injection molding, thereby making, for example, an accordion-shaped spring body extended downward from the base portion of the collar portion 51A of the piston valve 51.

Reasonably, if they can be integrally molded, the spring body can be in a shape of a coil, plate, or spring washer.

Furthermore, a spring body integrally molded with the piston cover 53 through injection molding can be adopted.

Also in this case, if they can be integrally molded, the spring body can be in a shape of a coil, plate, or spring washer.

(Trigger)

On the other hand, the trigger 3 that moves the piston structure 2 up and down is extended from a finger contact part so as to surround the narrow diameter portion 23A of the cylinder 11, and is pivotally attached to a rear portion of the base body 1 (a pivotally-attached portion P1).

The trigger 3 is pivotally attached to the piston portion 23 at a midpoint of the extended part.

In this case, paired circular protrusions not shown are formed on an outer wall of the narrow diameter portion 23A of the piston portion 23, and the paired circular protrusions fit in paired circular holes not shown of the trigger 3.

Therefore, when fingers are attached to the finger contact portion of the trigger 3 to rotate the trigger 3 downward with the pivotally-attached portion P1 as a starting point, the piston portion 23 goes down.

Here, since the trigger 3 is provided with a resilient force by a trigger spring 31 in a direction of reversing the trigger 3, the trigger 3 returns to the original position when the grasping fingers are released.

At this time, as described above, a reversion force of the coupling portion 22 of the piston structure 2 is also added.

Meanwhile, on the piston portion 23, an upper first sealing valve 23B1 and a second sealing valve 23B2 positioned lower than the first sealing valve 23B1 are formed for sealing the inside of the cylinder 11.

Also, a vent hole S1 is provided on a wall of the cylinder 11.

With these, a vent flow path for introducing outside air into the container body is formed.

This vent flow path is blocked or released with the first sealing valve 23B1 of the piston portion 23 sliding to make a pressure contact with the cylinder 11.

(Pressure-Accumulation Function)

Here, to present a pressure-accumulation function, which is an important part of the present invention, the action of the piston structure 2 together with the operation of the trigger 3 is described in detail.

First, it is assumed in the pressure-accumulation giving valve 5 that the piston valve 51 makes a pressure contact with the piston valve seat 23D (refer to FIG. 6(A)).

Now, the trigger 3 is pulled to inject liquid into a predetermined place.

The trigger 3 rotates with reference to the pivotally-attached portion P1, and the piston portion 23 is pressed downward.

With the downward movement of the piston portion 23, the liquid in the cylinder 11 receives pressure.

When the pressure exceeds a predetermined amount, the piston valve 51 opens with the liquid, thereby raising the liquid upward (that is, letting the liquid escape upward).

Specifically, the liquid in the cylinder 11 passes through the passage 53A of the piston cover 53 to forcefully enter an upper portion from a space between the piston valve 51 and the piston valve seat 23D to enter a passage in the coupling portion 22 (refer to FIG. 6(B)).

In this case, the fluid pressure surpasses the force of the spring body 52 to press the piston valve 51 down (that is, the piston valve 51 opens).

And, together with the downward movement of the piston portion 23, the liquid in the cylinder 11 is injected from the nozzle N of the nozzle portion 21 to the outside.

When the trigger 3 is released after the liquid is injected, the pulled trigger 3 goes to return to the original position with the reversion force of the trigger spring 31, thereby pulling up the piston portion 23 (at this moment in time, a space between the head portion of the piston valve 51 and the piston valve seat 23D is closed). When the piston portion 23 is pulled up, the cylinder 11 has a negative pressure. At this time, to revolve the negative pressure, the liquid in the container is drawn up into the cylinder 11. As a result, the cylinder 11 is filled with the liquid, thereby being ready again for the next liquid injection.

At the final stage after the trigger 3 is pulled, the second sealing valve 23B2 of the piston portion 23 reaches an area of a plurality of protrusions T formed on a lower inner radius surface of the cylinder 11.

Here, the lower inner radius surface is slightly bowed inward to form a large diameter surface 11D, and linear protrusions T are formed from the large diameter surface 11D.

The height of the protrusions T preferably coincides with the inner radius surface of the cylinder and, in this case, the second sealing valve 23B2 can smoothly pass.

Therefore, when the second sealing valve 23B2 passes through this area (FIG. 7(A) to FIG. 7(B)), a space is formed on both sides of the protrusions T to become a flow path through which liquid passes.

As indicated by an arrow, the liquid in the cylinder 11 passes through this space to be back (escape) into the container.

Then, the fluid pressure in the cylinder 11 is decreased to raise the piston valve 51 of the pressure-accumulation giving valve 5 with a spring force for closing.

With this state, so to speak, “cutting out” the liquid flowing out from the nozzle N without dripping becomes clearer.

Also, at the time of starting use, the trigger 3 must be chattered to let the air present in the cylinder escape to the outside to draw up the liquid from the container via the first valve FV, and it is possible to let the air escape from this passage.

Meanwhile, by pressing the piston portion 23 down, the nozzle portion 21 integrally formed therewith is also about to be pulled down. However, as described above, since the nozzle portion 21 is fixed between the base body 1 and the cover body 4, it is originally not pulled down (refer to FIG. 1 and FIG. 2).

However, here, the coupling portion 22 is bent and deformed to actively absorb a vertical movement of the piston.

In this manner, in the pressure-accumulation dispenser of the present embodiment, the piston portion 23 can make a vertical motion with the operation of the coupling portion 22 even when the nozzle portion 21 is fixed.

At the time of liquid injection, the liquid can be accurately injected into a target position with no vertical movement of the nozzle N.

### Second Embodiment

FIG. 8 is a section view depicting a pressure-accumulation dispenser of a second embodiment of the present invention before rotation of a trigger.

The pressure-accumulation dispenser of this embodiment has a feature such that, in contrast to the pressure-accumulation giving valve 5 of the first embodiment using part of the piston portion 23 as a valve seat (piston valve seat 23D), the pressure-accumulation giving valve itself includes a valve seat (that is, an insertion valve seat 54).

That is, the pressure-accumulation giving valve 5 is formed of the insertion valve seat 54, a piston valve 51 that abuts on or is isolated from the insertion valve seat 54, a spring body 52 that presses the piston valve 51 onto the insertion valve seat 54, and a piston cover 53 mounted on the insertion valve seat 54 through press-fit to accommodate the piston valve 51 and the spring body 52.

And, the insertion valve seat 54 has an upper portion mounted on the narrow diameter portion 23A of the piston portion through press-fit.

Therefore, the pressure-accumulation function can be achieved only with the pressure-accumulation giving valve 5.

The piston valve 51 closes or releases the flow path of liquid by abutting on or being isolated from the insertion valve seat 54.

The spring body 52 is resiliently disposed between the base of the collar portion 51A of the piston valve 51 and the bottom of the piston cover 53. With the collar portion 51A making a pressure contact with the inner radius of the piston portion, the spring body 52 becomes in a state of being sealed and trapped in the space between the piston valve 51 and the piston cover 53.

Even in a dispenser of a direct pressure type without using the pressure-accumulation giving valve 5, the pressure-accumulation function can be easily given by mounting the pressure-accumulation giving valve 5.

In this case, as with the first embodiment, the piston valve 51 and the spring body, and the piston cover 53 and the spring body can be integrally injection-molded.

### Third Embodiment

FIG. 9 is a cut-out view depicting a piston cover of a pressure-accumulation giving valve of the present embodiment, and FIG. 10 is a perspective view depicting a piston valve.

As depicted in these drawings, in a pressure-accumulation giving valve 5 of the present embodiment, a member for giving a resilient force to a piston valve 51 (corresponding to the spring body 52 of the above-described first and second embodiments) is formed of a blade spring 53B integrally configured in a standing state at the bottom of a piston cover 53.

The blade spring 53B is split into a plural number (here, three). That is, the blade spring 53B has three split pieces 53B1, 53B2, and 53B3 obtained by splitting in a direction of 120 degrees, each being at a position a predetermined distance away from the center of the piston cover 53.

In the present embodiment, the bottom surface of the piston valve 51 is a bowl-like tapered surface. For this reason, when the piston valve 51 is mounted in the piston cover 53, the upper end of the blade spring 53B abuts on the tapered surface. In this state, the piton valve 51 elastically presses the blade spring 53B upward to cause its head portion to make a pressure contact with the piston valve seat 23D.

Next, the action of the piston structure 2 together with the operation of the trigger 3 is described.

First of all, it is assumed in the pressure-accumulation giving valve 5 that the blade spring 53B presses the piston valve 51 upward to cause the head of the piston valve 51 to make a pressure contact with the piston valve seat 23D (refer to FIG. 11(A)).

First, the trigger 3 is pulled to pressed the piston portion 23 down, the liquid in the cylinder 11 receives a compression pressure to open the piston valve 51 to let the liquid escape upward. In detail, the liquid in the cylinder 11 with an increased pressure passes through the passage 53A of the piston cover 53 to forcefully flow into the passage in the coupling portion 22 from a space between the piston valve 51 and the piston valve seat 23D (refer to FIG. 11(B)). Then, the liquid is injected from the nozzle N.

After the liquid is injected from the nozzle N, the pulled trigger 3 goes to return to the original position with the reversion force of the trigger spring 31, thereby pulling up the piston portion 23 (at this moment in time, a space between the head portion of the piston valve 51 and the piston valve seat 23D is closed).

Then, the cylinder 11 has a negative pressure, and the liquid acts so as to open the space between the head portion of the piston valve 51 and the piston valve seat 23D, but this is inhibited by a spring force (reversion force) of the blade spring 53B, and the piston portion 23 is lifted upward with the piston valve 51 being in contact with the piston valve seat 23D.

At the same time, with the upward movement of the piston portion 23, the liquid in the container is drawn up into the cylinder 11 so as to resolve the negative pressure in the cylinder 11. With this, the cylinder 11 is filled with the liquid, thereby being ready again or the next liquid injection.

In this embodiment, the spring body 52 is integrally formed with the piston cover 53, thereby reducing the number of components. Also, when the piston valve 51 is moving upward and downward, each of the split blade springs 53B1, 53B2, and 53B3 of the blade spring 53B is always in the state of abutting on the tapered surface, and therefore these achieve a function as a guide for stabilizing the movement of the piston valve 51.

While the present invention has been described above, it goes without saying that the present invention is not restricted to only the embodiments described above and other various modifications can be made within a range of not deviating from the essence of the invention.

For example, although the cylinder 11 is vertically disposed by way of example, the present invention can be applied also to a cylinder laterally disposed, as a matter of course.

Also, although an example of the piston structure 2 is described, which is formed of the bendable coupling portion 22 that couples the nozzle portion 21 engaging with the base body 1 and the piston portion 23 together, the present invention can be applied also to a dispenser with a known nozzle portion going up and down.

In view of bendability and deformability, silicon resin or LLDPE resin is used for the piston structure 2, but another elastomer resin excellent in resilient bendability can be used only for the coupling portion.

### INDUSTRIAL APPLICABILITY

The present invention relates to a pressure-accumulation dispenser capable of injecting liquid when the liquid in the cylinder has a pressure higher than a predetermined pressure. With a pressure-accumulation giving valve 5 included in a piston portion, the pressure-accumulating giving valve 5 is accommodated in the piston portion 23 to decrease the capacity of a portion having a pressure-accumulation function, thereby easily achieving a pressure-accumulation dispenser when mounted on a conventional dispenser of a direct pressure type without including a pressure-accumulation function. As long as this principle can be adopted, the invention can be used irrespectively of the presence or absence of a trigger type.

### BRIEF DESCRIPTION OF THE DRAWINGS

FIG. 1 is a section view depicting a pressure-accumulation dispenser of a first embodiment of the present invention before rotation of a trigger.

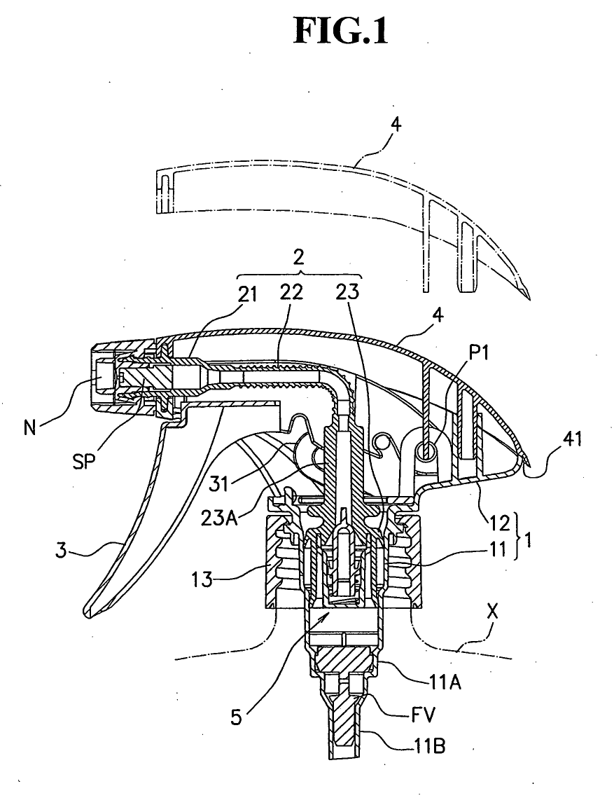

FIG. 2 is a descriptive diagram depicting the pressure-accumulation dispenser of the first embodiment of the present invention after rotation of the trigger.

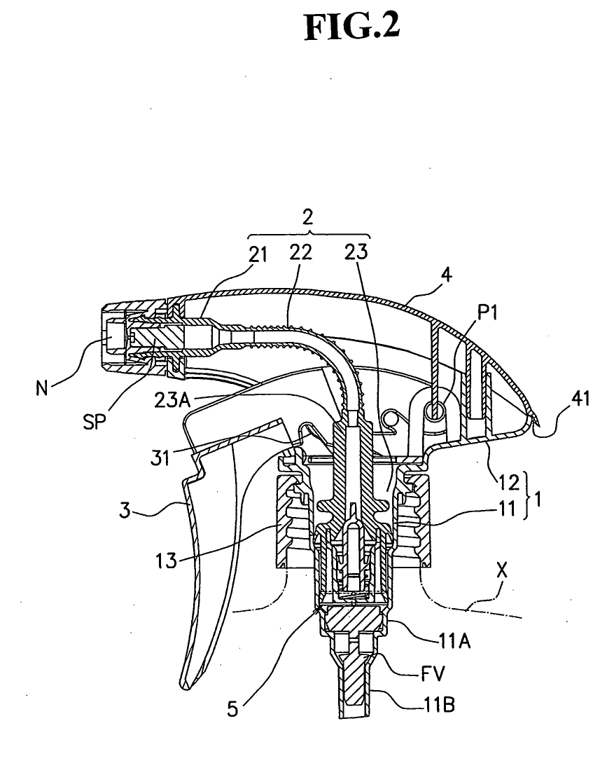

FIG. 3 is a diagram depicting a piston structure and a pressure-accumulation giving valve.

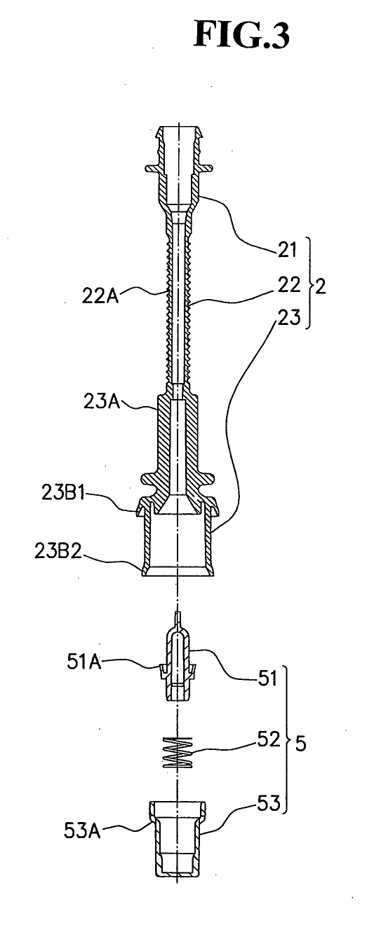

FIG. 4 is a diagram depicting a piston valve, which is a component of the pressure-accumulation giving valve.

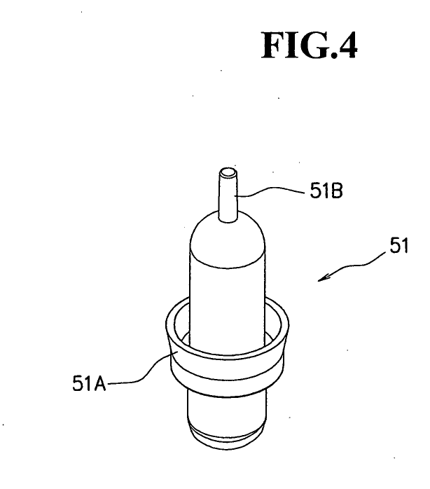

FIG. 5 is a diagram depicting a piston cover, which is a component of the pressure-accumulation giving valve.

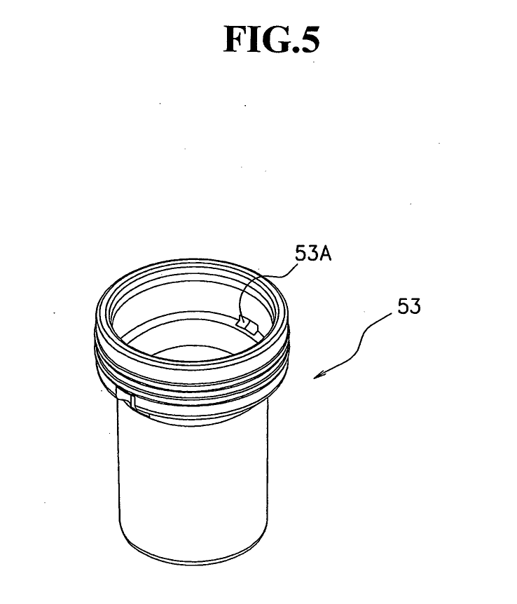

FIG. 6 shows section views for describing the motion of the pressure-accumulation giving valve, (A) depicting a state in which a space between the piston valve and a piston valve seat is closed and (B) depicting a state in which the space between the piston valve and the piston valve seat is open.

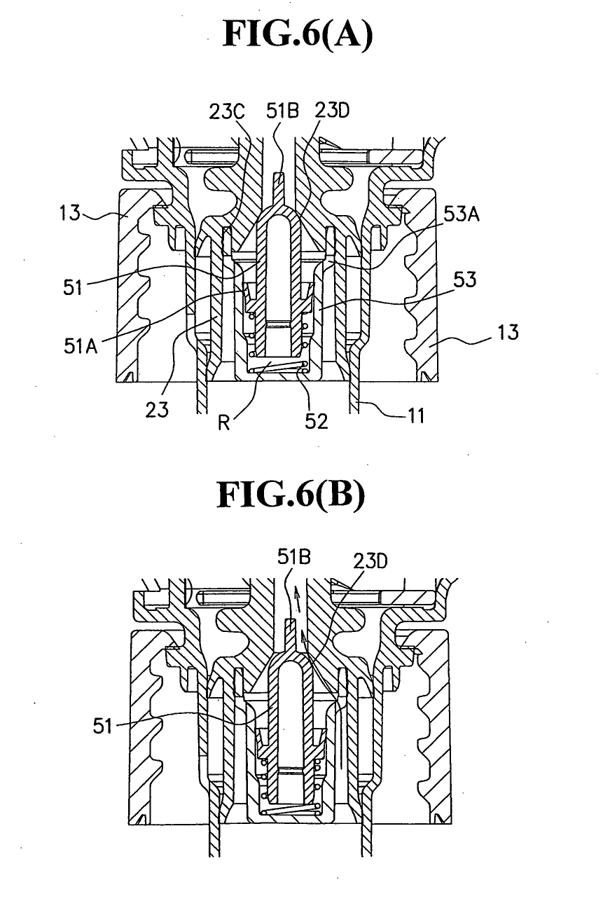

FIG. 7 shows section views for describing formation of a flow path out of a protrusion, (A) depicting a state in which a passage of liquid is closed and (B) depicting a state in which the passage of liquid is open.

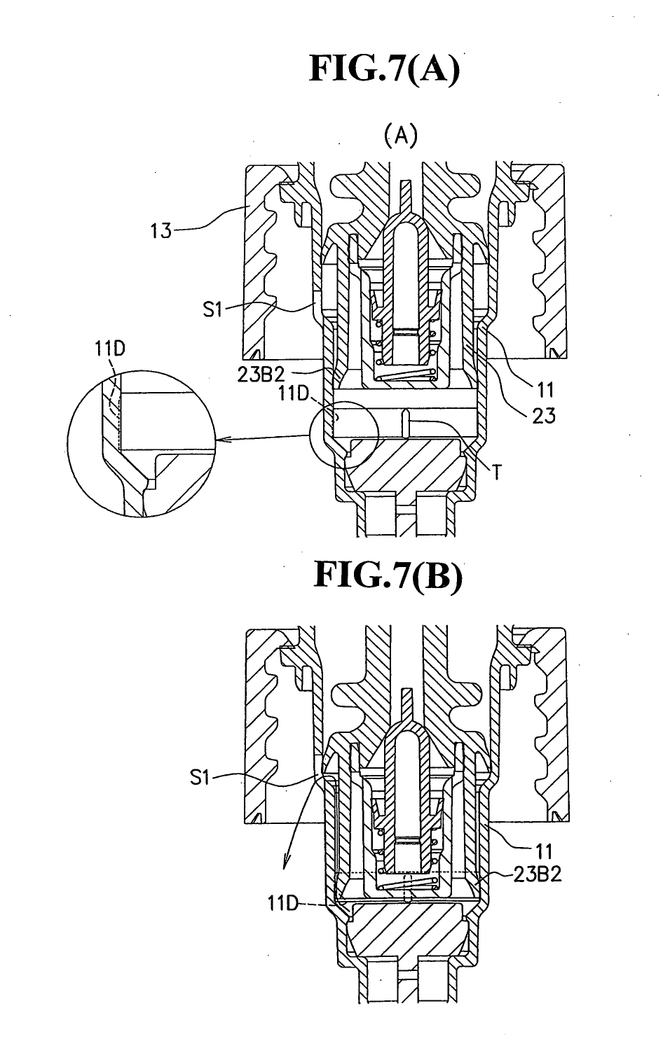

FIG. 8 is a section view depicting a pressure-accumulation dispenser of a second embodiment of the present invention before rotation of a trigger.

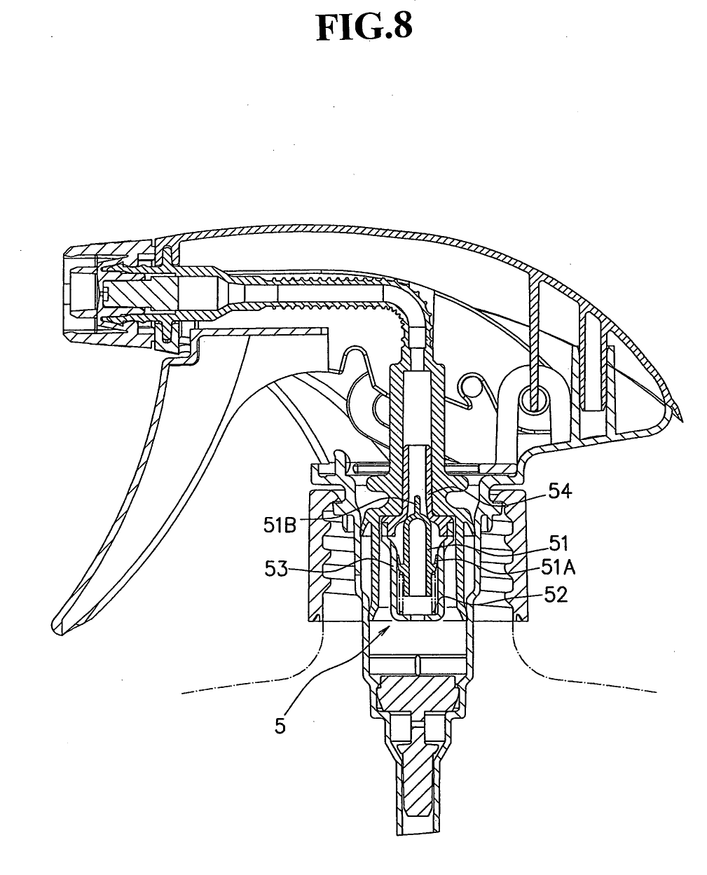

FIG. 9 is a section view depicting a pressure-accumulation giving valve of a third embodiment of the present invention.

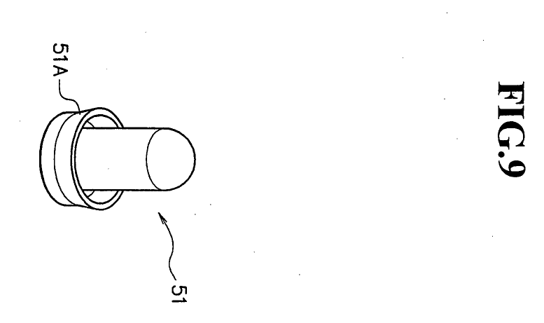

FIG. 10 is a perspective view depicting a piston valve.

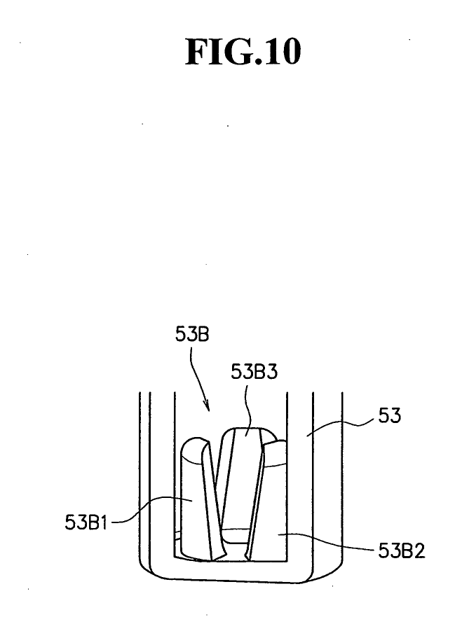

FIG. 11 shows section views for describing the motion of the pressure-accumulation giving valve of the third embodiment, (A) depicting a state in which a space between a piston valve and a piston valve seat is open and (B) depicting a state in which the space between the piston valve and the piston valve seat is closed.

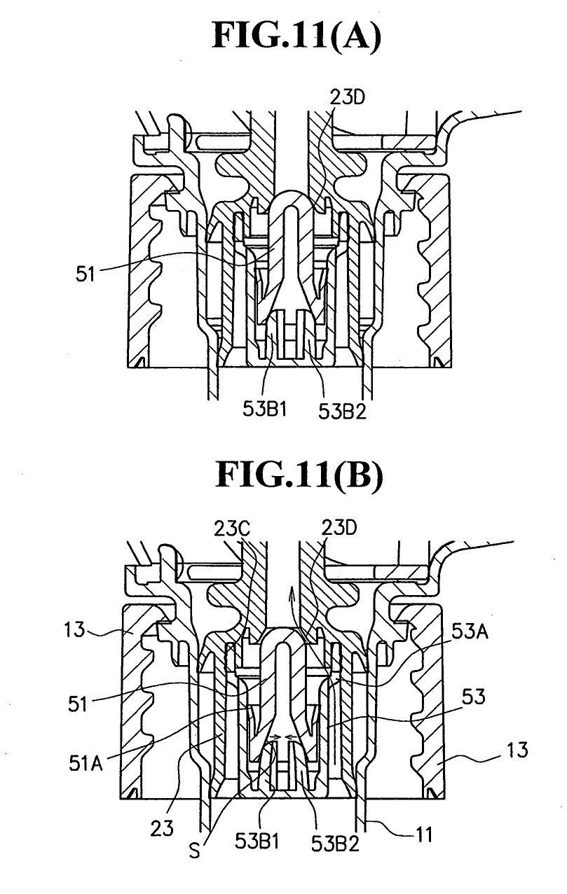

### DESCRIPTION OF REFERENCE NUMERALS

1 . . . base body
11 . . . cylinder
11A . . . step-like barrel portion
11B . . . introduction tube
11D . . . large diameter portion
12 . . . expanded portion
13 . . . cap
2 . . . piston structure
21 . . . nozzle portion
22 . . . coupling portion
22A . . . fin
23 . . . piston portion
23A . . . narrow diameter portion
23B1 . . . first sealing valve
23B2 . . . second sealing valve
23C . . . groove
23D . . . piston valve seat
3 . . . trigger
31 . . . trigger spring
4 . . . cover body
41 . . . eaves portion
5 . . . pressure-accumulation giving valve
51 . . . piston valve
51A . . . collar portion
51B . . . protrusion
52 . . . spring body
53 . . . piston cover
53A . . . passage
53B . . . blade spring
53B1 . . . split blade spring
53B2 . . . split blade spring
53B3 . . . split blade spring
54 . . . insertion valve seat
FV . . . first valve
SP . . . spinner
N . . . nozzle opening
S1 . . . vent hole
P1 . . . pivotally-attached portion
R . . . accommodating portion
T . . . protrusion

1. A pressure-accumulation dispenser that pressurizes and injects liquid in a cylinder from a nozzle portion to outside by sliding a piston portion in the cylinder up an down with rotation of a trigger, the pressure-accumulation dispenser comprising a pressure-accumulation giving valve in the piston portion.

2. The pressure-accumulation dispenser according to claim 1, wherein the pressure-accumulation giving valve is formed of a piston valve, a spring body that presses the piston valve onto a piston valve seat, and a piston cover that accommodates the piston valve and the spring body.

3. The pressure-accumulation dispenser according to claim 1, wherein the pressure-accumulation giving valve is formed of an insertion valve seat, a piston valve that abuts on or is isolated from the insertion valve seat, a spring body that presses the piston valve onto the insertion valve seat, and a piston cover mounted on the insertion valve seat through press-fit to accommodate the piston valve and the spring body.

4. The pressure-accumulation dispenser according to claim 2, wherein the pressure-accumulation giving valve is mounted by being pressed fit into a groove formed in the piston portion.

5. The pressure-accumulation dispenser according to claim 3, wherein the insertion valve seat mounted by being pressed fit into a narrow diameter portion of the piston.

6. The pressure-accumulation dispenser according to claim 2, wherein a collar portion is provided around the piston valve to seal inside of the piston cover to form an accommodating portion for the spring body.

7. The pressure-accumulation dispenser according to claim 2, wherein the liquid in the cylinder passes through a passage hole formed in the piston cover and then through the piston valve seat.

8. The pressure-accumulation dispenser according to claim 2, wherein the piston valve and the spring body are integrally molded.

9. The pressure-accumulation according to claim 2, wherein the piston cover and the spring body are integrally molded.

10. The pressure-accumulation dispenser according to claim 9, wherein the spring body is formed of a split blade spring integrally formed at a bottom of the piston cover, a tapered portion is formed inside of the piston valve, and the blade spring abuts on a tapered surface of the tapered portion to press the piston valve onto the valve seat.

11. The pressure-accumulation dispenser according to claim 1, wherein a large diameter portion is provided on a lower inner radius surface of the cylinder, and a plurality of protrusions are formed on the large diameter portion.

12. A pressure-accumulation dispenser that pressurizes and injects liquid in a cylinder from a nozzle portion to outside by sliding a piston portion in the cylinder up and down with rotation of a trigger, the pressure-accumulation dispenser comprising:
a base body including a cylinder therein and mountable on an opening portion of a container body;
a cover body removably engaged with the base body;
a piston structure formed of a bendable coupling portion that couples the nozzle portion engaging with the base body and the piston portion together;
a trigger rotatably mounted on the base body so as to slide the piston up and down in the cylinder; and
a pressure-accumulation giving valve disposed in the piston portion, and
the pressure-accumulation giving valve formed of a piston valve, a spring body that presses the piston valve onto a piston valve seat, and a piston cover that accommodates the piston valve and the spring body.

13. The pressure-accumulation dispenser according to claim 8, wherein the many fins are formed around the coupling portion of the piston structure.
